(19) United States
(12) Patent Application Publication
(10) Pub. No.: US 2007/0141342 A1
(43) Pub. Date: Jun. 21, 2007

(54) Physical color new concepts for color pigments

(76) Inventors: Manfred R. Kuehnle, Lincoln, MA (US); Hermann Statz, Wayland, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/514,733

(22) Filed: Aug. 31, 2006

Related U.S. Application Data
(63) Continuation-in-part of application No. 10/987,193, filed on Nov. 12, 2004, now abandoned.
(60) Provisional application No. 60/519,178, filed on Nov. 12, 2003.

(51) Int. Cl. B32B 5/16; B32B 15/02; B32B 17/02

(52) U.S. Cl. 428/403; 428/404; 428/405

(57) ABSTRACT

An electromagnetic radiation-absorbing particles comprising cores; a first shell encapsulating the core; and at least one additional shell encapsulating the first shell. The first shell has the refractive index different from the refractive index of the core and the refractive index of the at least one additional shell.

### RELATED APPLICATION

This application is a continuation-in-part of the U.S. application Ser. No. 10/987,193, filed on Nov. 12, 2004, which claims the benefit of U.S. Provisional Application No. 60/519,178, filed on Nov. 12, 2003. The entire teachings of the above applications is incorporated herein by reference.

### BACKGROUND

Transparent and translucent materials such as glass, plastic, gels, and viscous lotions have for many years been combined with coloring agents to alter their optical transmission properties. Agents such as dyes and pigments absorb radiation within a characteristic spectral region and confer this property on materials in which they are dissolved or dispersed. Selection of the proper absorptive agent facilitates production of a composite material that blocks transmission of undesirable light frequencies.

Beer bottles, for example, contain additives that impart a green or brown color to protect their contents from decomposition. These include iron (II) and iron (III) oxides in the case of glass bottles, while any of a variety of dyes can be employed in plastic containers. The concentration of these additives (in weight percent relative to the surrounding carrier material) is generally very heavy, in the range of 1-5%. This results in a highly expensive dispersion within the carrier, and the need to employ special mixing techniques to counter strong agglomeration tendencies.

Applied colorants such as paints and inks are used to impart a desired appearance to various media, and are prepared by dissolving or dispersing pigments or

Applied colorants such as paints and inks are used to impart a desired appearance to various media, and are prepared by dissolving or dispersing pigments or dyes in a suitable carrier. These materials also tend to require high pigment or dye concentrations, and are vulnerable to degradation from prolonged exposure to intense radiation, such as sunlight. The limited absorption and non-uniform particle morphology of conventional pigments tends to limit color purity even in the absence of degradation.

Most commercially useful coloring agents absorb across a range of frequencies; their spectra typically feature steady decrease from a peak wavelength of maximum absorption, or λₘₐₓ. When mixed into a host carrier, such materials tend to produce fairly dark composite media with limited overall transmission properties, since the absorption cannot be “tuned” precisely to the undesirable frequencies. If used as a container, for example, such media provides relatively poor visibility of the contents to an observer.

Traditional means of forming particles that may serve as coloring agents frequently fail to reliably maintain uniform particle size due to agglomeration, and cause sedimentation during and/or after the particles are generated. The problem of agglomeration becomes particularly acute at very small particle diameters, where the ratio of surface area to volume becomes very large and adhesion forces favor agglomeration as a mechanism of energy reduction. While suitable for conventional uses, in which radiation absorption is imprecise and largely unrelated to particle size or morphology, non-uniform particles cannot be employed in more sophisticated applications where size has a direct impact on performance.

Certain radiation-absorption properties of select conducting materials, known as Froehlich or plasmon resonance, can be exploited to produce highly advantageous optical properties in uniform, spherical, nanosize particles. See, for example, U.S. Pat. No. 5,756,197. These particles, we showed, may be used as optical transmission-reflection “control agents” for a variety of products that require sharp transitions between regions of high and low absorption, i.e., where the material is largely transparent and where it is largely opaque. A key physical feature of many suitable nanosize spherical particles as per our invention is “optical resonance”, which causes radiation of a characteristic wavelength to interact with the particles so as to produce “absorption cross-sections” greater than unity in certain spectral regions; in other words, more radiation can be absorbed by the particle than actually falls geometrically on its maximum cross-sectional area. Conventional pigments offer absorption cross-sections that can only asymptotically approach, but never exceed, a value of 1, whereas our resonant particles can exhibit cross-sections well in excess of (e.g., 3-5 times) their physical diameters.

Unfortunately, the physical properties of most materials, suitable for manufacturing of such resonant particles, result in the absorption peaks being located in undesirable spectral bands. For example, many metals exhibit the plasmon resonance in the ultraviolet region of the electromagnetic spectrum, thus making these materials unusable for production of visible range colorants. Either varying the refraction properties of a carrier or the size of the particles may introduce variation in absorption peak. Both of these methods, however, would produce undesirable effects such as excessive scattering by the particles or absorption by the carrier.

The need, therefore, exists for compositions and methods of manufacture of optically resonant, narrow-band frequency response nanoparticles of equal size, equal shape, and equal chemistry that would allow for tuning the peak of resonance absorption through a desired spectral band while in a non-agglomerated dispersion state.

### SUMMARY OF THE INVENTION

The present invention relates to the selective absorption of electromagnetic radiation by small particles, and more particularly to solid and liquid composite materials that absorb strongly within a chosen, predetermined portion of the electromagnetic spectrum while remaining substantially transparent outside this region.

In one embodiment, the present invention is an electromagnetic radiation-absorbing particle, comprising (a) a core; (b) a first shell encapsulating the core; and (c) at least one additional shell encapsulating the first shell. The first shell has the refractive index different from the refractive index of the core and the refractive index of the at least one additional shell.

Preferably, the particles of the present invention have of a diameter between 1 nm to 300 nm. In one embodiment, the particles are substantially spherical. In another embodiment, the particles of the present invention have a substantially equal-size core.

The particles of the invention, when in substantially uniform dispersion act collectively to reduce the loading factor and to achieve desired optical and electronic energy amplification

The present invention discloses materials and methods that advantageously allow tuning the absorption peak of the colorant throughout the infrared, visible and ultraviolet portion of the electromagnetic spectrum while the colorant remains substantially transparent to other wavebands.

The materials of the present invention can be used to absorb or scatter light at specific wavelengths in the visible or infrared range, in paints, windows, coatings, fabrics, or inks. The materials of the present invention can be adsorbed onto or embedded into materials, thin films, coatings, or fabrics. Such materials can be used, for example, for laser eye protection or skin UV radiation protection.

Furthermore, particles of the present invention specifically possess the “optical resonance” property, which causes radiation of a characteristic wavelength to interact with the particles so as to produce “absorption cross-sections” greater than unity in certain spectral regions; in other words, more radiation can be absorbed by the particle than actually falls geometrically on its maximum cross-sectional area. Accordingly, lesser amount of a colorant of the present invention is required to achieve a given level of absorption than of colorants of prior art.

### BRIEF DESCRIPTION OF THE DRAWINGS

FIG. 1. Absorption Cross Section of three spheres with radii 0.055 micron, 0.065 micron and 0.078 micron. The refractive index is 4 and its imaginary part is 0.1, values not far from those of Silicon. The visible spectrum is from 0.4 to 0.7 micron wavelength. The spheres with radii of 0.055 and 0.065 micron have only one absorption peak in the visible spectrum, while the sphere with a radius of 0.078 micron has two such absorption peaks (resonances). The visible spectrum goes from 0.4 to 0.7 micron.

FIG. 2. ZrN particles with a radius of 0.022 μm , uncoated and coated with 0.005 μm and 0.01 μm of TiO₂. Scattering is negligible as seen from the near coincidence of the extinction and absorption cross-sections. The index of the dispersant medium is N=1.33 (water).

FIG. 3. ZrN spheres with a radius of 0.02 μm coated with crystalline Si films with a thickness of 0, 1, 2, 3 and 4 nm. The medium around the coated spheres is assumed to have an index of 1.33 (water).

FIG. 4. Dielectric cores of indicated diameter and an index of refraction of 1.33 coated with ZrN. The total particle diameter is 40 nm. The index of the medium is also assumed to be 1.33.

FIG. 5. Absorption and extinction cross-sections for uncoated and coated Silver spheres with a diameter of 44 nm. The coating thickness varies from zero to 10 nm as indicated. One can place in this manner an absorption line anywhere in the visible spectrum. The assumed medium is waterlike with N=1.33.

FIG. 6. Absorption (solid lines) and extinction (dashed lines) cross-sections for TiO₂ coated Silver spheres with a diameter of 40 nm. The coating thickness varies from 1 to 10 nm as indicated. The assumed medium is waterlike with N=1.33.

FIG. 7. Magnesium Spheres coated with a thin layer of crystalline Si give absorption peaks in the visible spectrum. The light dashed lines represent extinction.

FIG. 8. Aluminum Spheres coated with layers of crystalline Si give absorption peaks in the near ultra-violet and visible spectrum. The light dashed lines represent extinction.

FIG. 9. Mg spheres with radius Of 22 nm coated with the more absorbing Hydrogenated Amorphous Silicon (layer thickness as indicated).

FIG. 10. We are depicting an Aluminum nanosphere of 40 nm diameter. Inside the sphere we have an enclosed shell of a dielectric medium (N=1.33) of a thickness of 4 nm. The position of this shell is varied from near the outer edge of the particle to a more inside position.

FIG. 11. This is a variation of FIG. 10 with an Al core followed by a dielectric layer (N=1.33), followed in turn by an Al outer shell. Here we vary the dielectric shell thickness while leaving the outer Al shell unchanged.

FIG. 12. We illustrate how the Al plasmon resonance, normally near 0.2 μm, can be shifted first by a dielectric core of 34 nm diameter (N=1.33) to the edge of the visible spectrum and then shifted further into the visible spectrum by an outside coating of TiO₂ from 1 to 5 nm. The example applies to a 3 nm thick Al inner shell.

FIG. 13 is a schematic representation of the manufacturing process that can be used to produce the particles of the present invention.

FIG. 14A shows a detailed schematic diagram of the nanoparticles production system.

FIG. 14B is a detail of FIG. 14A.

FIG. 15 depicts the steps of particle formation.

### DETAILED DESCRIPTION OF THE INVENTION

Color by Resonance Entrapment of Radiation in Nonmetallic Dielectric Spheres

It is well known from microwave technology that good cavities can be made from a high dielectric constant material alone, without any metallic walls. Radiation can be trapped by total or near total reflection from dielectric air boundaries (R. E. Collins, Field Theory of Guided Waves, IEEE Press, Piscataway, N.J. 1991, p461).

In the approximation of large indices of refraction, n (n being the square root of the dielectric constant), it can be shown that the three longest wavelengths resonances of a spherical cavity having radius r in a dielectric material having index of refraction n are approximately:
λ₁=2nr
λ₂=1.4nr
λ₃=1.12nr

Thus, for a constant r and n, (i.e. for an n independent of wavelength) when resonant absorption at the λ₂ wavelength just enters the visible spectrum at 0.4 micron then the peak absorption at the longest wavelength λ₁ lies at 0.572 micron, which is near the transition from the green to the red portion of the spectrum. Thus if n is constant and independent upon wavelength then one can have only one absorption line anywhere in the spectrum between 0.4 and 0.572 micron. As the radius of the sphere becomes larger then at some point the λ₃ resonance enters the visible spectrum at 0.4 micron while the λ₂ resonance moves to 0.5 micron and the λ₁ resonance goes to 0.714 micron, which is near the boundary of the red and infrared spectrum. Often the index n becomes smaller as the wavelength increases. This has the effect of pushing the resonances closer together in wavelength and thus making it more difficult to have only one resonance in the visible spectrum. This is one of the limiting factors that has to be kept in mind when considering resonance colors, based on resonance entrapment.

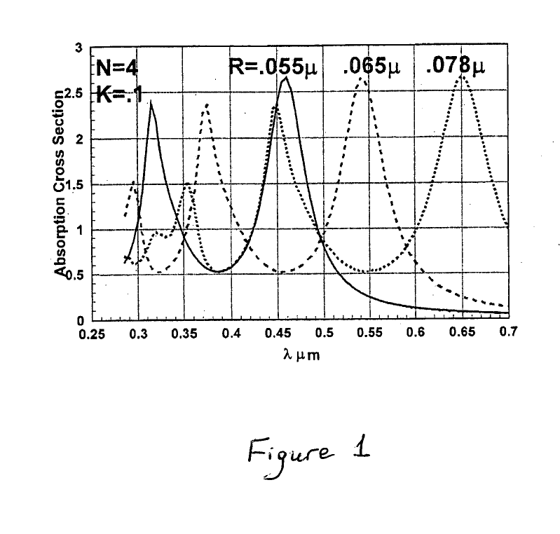

This is illustrated in FIG. 1 that shows the absorption cross sections of three spheres with different radii. The index of the material was chosen to be 4. The material is preferably at least weakly absorbing or otherwise, even in the presence of resonances, there could not be any absorption. The index of refraction is a complex number with an imaginary part of 0.1. These index values are not far from those of crystalline Silicon. A complex index implies absorption losses in the material.

A strong and well-confined resonance requires a situation where the quality factor Q of the cavity is reasonably good. The half width of a resonance is Δλ=λ/Q. Thus a Q of 10 for a resonance at 0.5 micron gives a half width of the resonance of the absorption of 0.05 micron. The losses due to radiation leakage alone depend upon n. A complex index (n+ik) causes additional losses through absorption in the spherical dielectric resonator thus broadening the resonance

It can be shown that values for n that lie in the range of 4 and higher give the preferred half widths of absorption. Indices of such value are very uncommon in transparent materials. Diamond has an n value of about 2.4. The imaginary value of the index is preferably somewhere in the range of about 0.01 to 0.4.

Desirable materials, which show indices of refraction as well as k values in the right range of values, include common semiconductor materials such as Silicon, Germanium and Silicon Germanium alloys and other indirect semiconductors. Choosing the right value of absorption is also important because on the one hand it increases the absorption while on the other hand it reduces the scatter. The reduction of scatter with increasing absorption near resonance is a very important concept for color pigments.

Metal Pigment Absorption by Froehlich Resonance

The resonance by free electrons in conductors goes under both the names of Froehlich and Plasmon resonance.

Metals have very different properties than pigments or resonant high dielectric constant spheres. The index of refraction usually has only a small real part indicating low or no trapping of radiation inside the sphere and any radiation trapped there would get absorbed very rapidly so that bulk resonance modes would hardly be expected. In the long distant past colloidal gold particles were empirically used to color ornamental glass windows with a deep red color.

The peculiar property which is here of central importance is the fact that in many metals the real part of the dielectric constant is negative for optical frequencies. For those skilled in the art it would be known that totally unbound and free electrons would show at all frequencies a negative real part of the dielectric constant. Note that in reality the electrons are not totally free, and other absorptive effects from non-free electrons may also be present.

Traditionally Gold and Silver spheres are regarded as good candidates for Plasmon resonance. Gold has a resonance in the visible leading to red colors. Because of its high cost it is not considered as a candidate for commercial pigments. Silver has a resonance at the boundary between the ultraviolet and the visible spectrum. Among others, Aluminum, Magnesium, Chromium, Nickel, Cupper, the Nitrides of Titanium, Zirconium and Hafnium can be used for many applications in conjunction with the tuning methods which are subject of this invention.

It is known from electrostatics that E_{inside}, the field inside the sphere is given by:

$${E}_{inside} = {E}_{outside} \frac{3 {ɛ}_{outside}}{2 {ɛ}_{outside} + {ɛ}_{inside}}$$

where E_{outside} is the surrounding electric field, and ε_{inside} and ε_{outside} are the (real) relative dielectric constants inside the sphere and in the surrounding medium, resp. From the above equation it becomes immediately obvious that the field inside the sphere would become infinitely large if the condition
2ε_{outside}+ε_{inside}=0
would be satisfied. Since the dielectric constants at the optical frequencies are not purely real the field would become only large but not infinite. In case of an oscillating electric field that is a part of the light wave, we can expect a correspondingly large enhancement of the field inside a particle provided the particle is small as compared to a wavelength and that the above resonance condition is satisfied. A large field would, of course, also result in a correspondingly large absorption by the metal.

From the equation above the maximum absorption wavelength shifts when the dielectric constant of the medium is changed. This would be one of several ways of fine-tuning the color from a Plasmon resonance in a given conductor.

For example, the real parts of the dielectric constant of the metals TiN, ZrN and HfN are negative and, for most media with indices of refraction in the range of 1 to 2, the condition for resonance can be satisfied.

It can be shown that particle size does not change the absorption position significantly, but large particles gradually lose their resonant character and scattering of radiation increases, as one would expect. One reason why larger particles become less effective as absorbers is the fact that the material occupying the innermost portion of the sphere never sees the light that they might absorb because the outer layers have already absorbed the incident resonance radiation.

The extinction cross section is the sum of the absorption and scattering cross sections. For larger spheres the resonance character gradually vanishes. The absorption and extinction cross sections start to be less pronounced as the size of the sphere grows. Absorption and especially extinction shifts also more to the red, i.e. longer wavelengths.

Coated Metallic Particles

As stated above, Froehlich or plasmon resonance is affected by the dielectric constant of the suspension medium in which the particle resides. Thus one expects that a high dielectric constant coating will also shift the plasmon resonance to the red. Similarly if the inner core of a metallic particle is replaced by a dielectric substance one similarly expects a red shift in the plasmon resonance. The degree of the shift will depend on the magnitude of the dielectric constant as well as the thickness of the coating or the relative dimension of the dielectric core. Similarly one can have a nanosphere consisting of two different metals. The resulting resonance lies somewhere in between the resonances of the pure metal spheres and also the position of the resonance depends on the relative volume of the shell and the core.

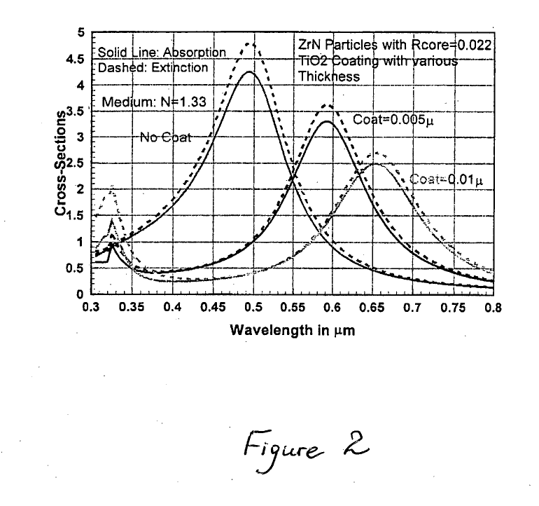

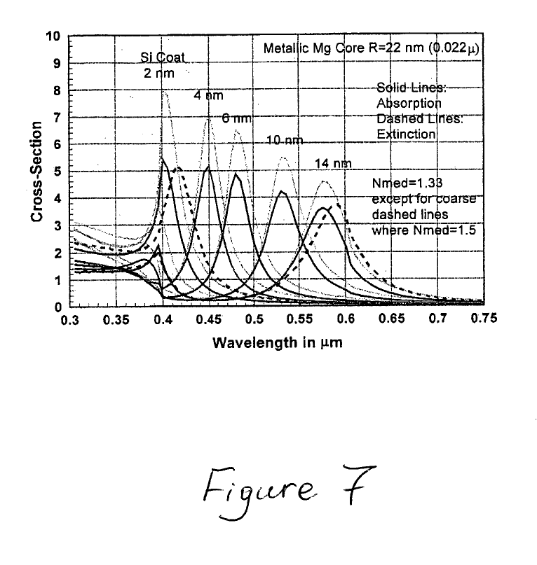

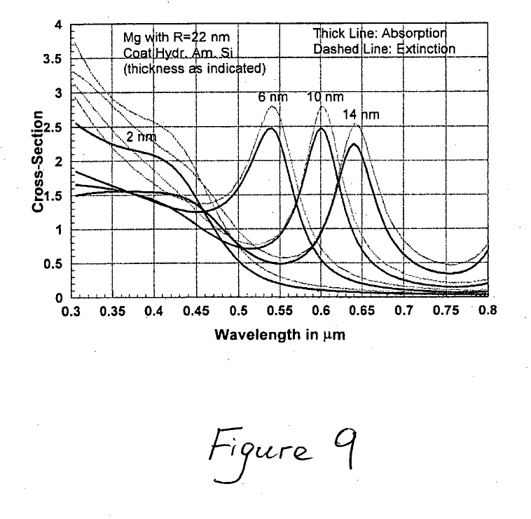

In one embodiment, the present invention is a metallic particle coated with a dielectric material. Depending on the thickness of the coating and the magnitude of the index of the coating a shift of the resonance line and color is seen. (FIG. 2, FIG. 7, FIG. 9) Usually the cross section based on the radius of the combined or coated particle decreases, but still stays comfortably above unity.

FIG. 2 illustrates ZrN cores coated with TiO₂ of a thickness of 5 and 10 nm.

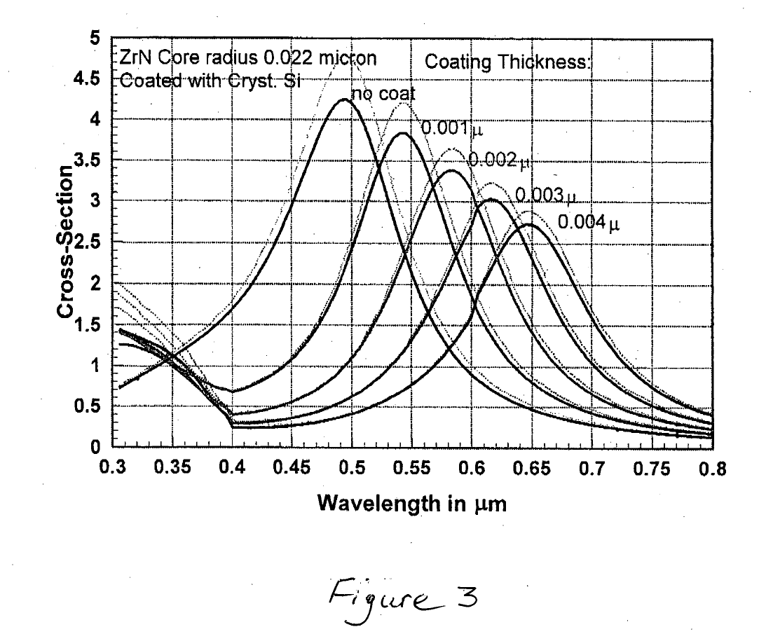

By using a coating with a higher dielectric constant material, such as crystalline Si a thinner coat is required for achieving a given absorption band shift. The absorption cross section is also slightly higher for the coating with the higher dielectric constant. This is also illustrated in FIG. 3.

FIG. 7 illustrates Mg spheres. The uncoated particle has a resonance in the ultra violet spectrum. A coating of crystalline Silicon brings the resonance absorption into the visible spectrum. The absorption position is a function of the coating thickness, as illustrated. We also illustrated the absorption shift with the index of the medium. For the solid absorption lines N_{med}=1.33, for the two heavy dashed lines the index is 1.5. The fractional shift is smaller for the 14 nm coating thickness, as one would expect.

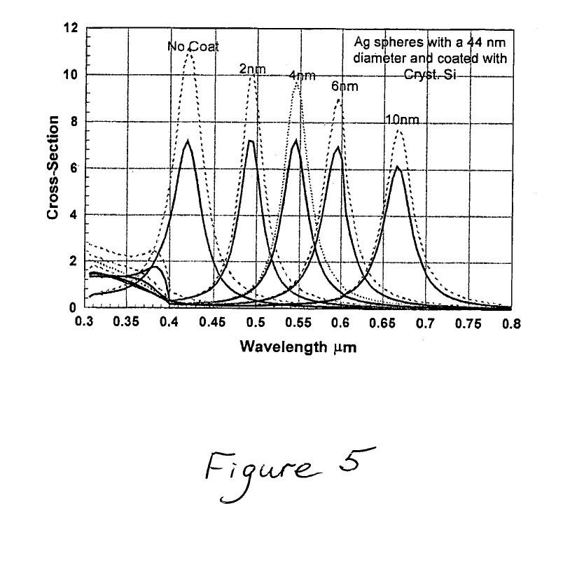

Ag metal is a very good free electron conductor. Its resonance as a function of Silicon coating thickness is shown in FIG. 5

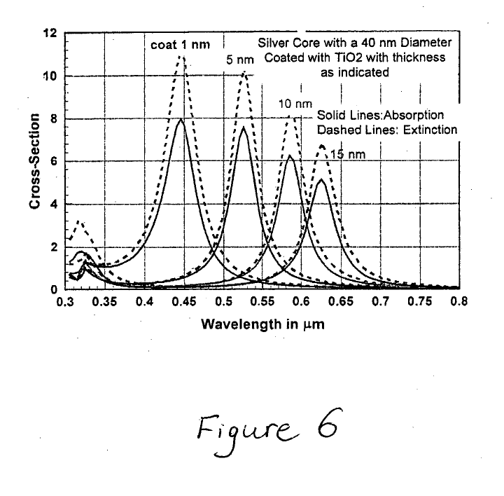

Silver spheres may also be coated with TiO₂ as shown in FIG. 6.

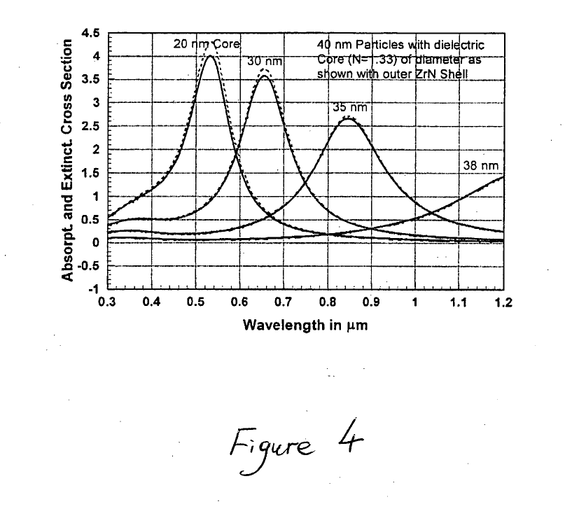

FIG. 4 illustrates yet another way to shift the resonance of ZrN to longer wavelengths. A dielectric core surrounded with, for example, ZrN, exhibiting free electron behavior, gives also a red shifted plasmon resonance. In general this method achieves the best absorption characteristics with the sparing use of free electron materials. The greater the volumetric fraction of the core the larger is the red shift. Also the larger the index of refraction of the core the larger is the red shift. All the other Froehlich resonance materials will experience essentially similar shifts.

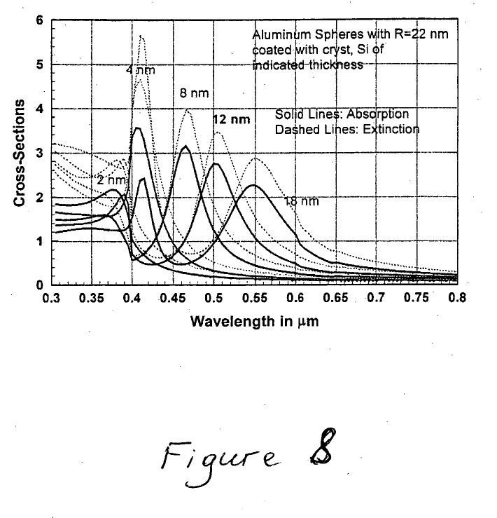

A 44 nm diameter Al core is coated with crystalline Si is and the results are presented in FIG. 8. Aluminum has a Froehlich resonance deeper in the ultra-violet spectrum. Thus a 2 nm Si coat brings the resonance not yet quite into the visible spectrum. The thick 18 nm Si coat (brown curve) makes a resonator exhibiting two modes: This is a new effect and results from having a Plasmon resonance and an entrapment resonance in the same particle at the same time. The normal red shifted Froehlich resonance is near 0.55 μm and a second mode near 0.42 μm is mainly a dielectric resonator mode in the Si coating, as discussed above in conjunction with pure Si spheres.

It can be shown that Magnesium spheres with a diameter of 44 nm coated with hydrogenated amorphous Silicon. Because of the much larger absorption of light by this form of Silicon the resulting resonance peaks are somewhat diminished and there is considerable absorption in the UV and blue portion of the spectrum as well.

In summary, most metals that do have a Froehlich resonance have this resonance in the ultra violet spectrum. This resonance can be shifted to the visible part of the spectrum with a high dielectric constant (high index of refraction) coating. Alternatively, two different free electron materials can be used in a core/ shell combination for the purpose of tuning the resonance position. In particular one can coat ZrN with Al (or Mg) and shift the resonance of pure ZrN more toward shorter wavelengths (color tuning). Because of the reactivity of Al with oxygen it is better to use an Al core and coat it with a thick film of ZrN.

In another example, TiN spheres (R=22 nm) are coated with 1 and 2 nm of Al. Obviously the absorption peak can be shifted from its uncoated sphere position at about λᵣₑₛ≈0.6 μm to any position towards the blue spectrum, depending on the thickness of the Al film.

Particles having a Core and at Least Two Coatings (Shells)

Particles with two and three shells give additional degrees of freedom for achieving more complex tasks. We may have two peak absorptions which can be tuned separately. These two peaks may be in the visible or one in the visible and the other in the infrared or ultraviolet spectrum. The use of dielectric layers between free electron materials layers usually separates the resonances of the different free electron material layers and the thickness of the dielectric layers relative to the conducting layers allows tuning of the different free electron resonances. In addition we shall show that there are repulsive effects between two Plasmon resonance peaks.

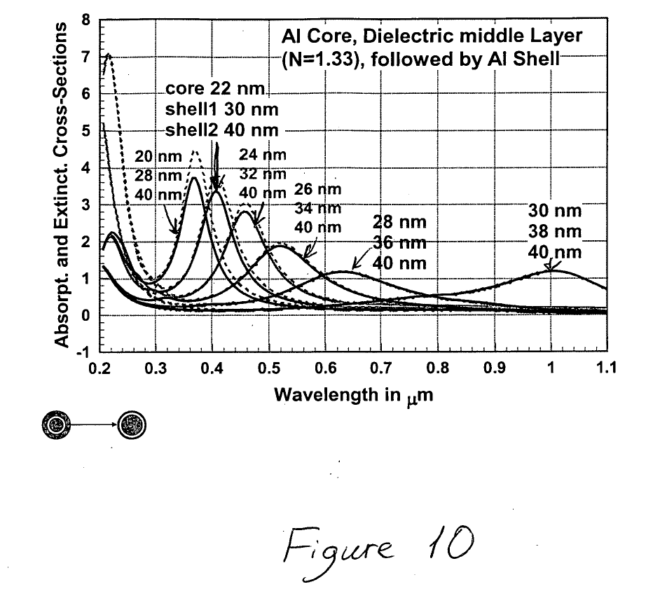

FIG. 10 shows absorption (solid) and extinction (dash) of a particle comprising an Al core, a first dielectric shell with N=1.33 and a thickness of 4 nm and a second aluminum shell over the first shell. The total particle size is 40 nm. The normally single deep UV resonance of Al is now joined by a second resonance. This resonance basically belongs to the outer Aluminum shell. It is shifted toward the red and the red shift is the larger the thinner the outside Al shell. However the amplitude of the resonance eventually decreases as the outer shell becomes thinner.

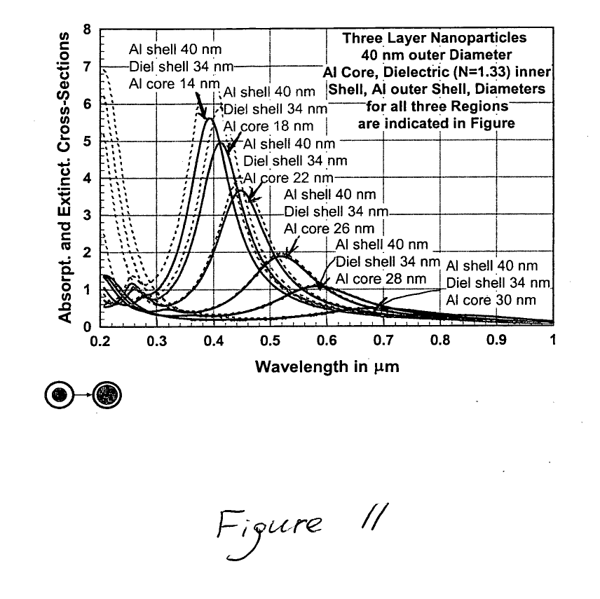

In FIG. 11 the dimensions of the layers are modified. The outer Al layer is the same, with an outside diameter is 40 nm and the inner diameter is 34 nm. Of course, the dielectric middle layer always has therefore an outer diameter of 34 nm also. The diameter of the Al core diameter is varied from 14 nm to 30 nm. This means that the inner diameter of the middle dielectric layer goes also from 14 to 30 nm. For the small core of 14 nm there is almost no effect from the core. A red shifted single Al resonance can be observed. It resembles a two layer particle consisting of a dielectric core and an Al shell. As the core grows and the dielectic shell shrinks we see the emergence of a uv resonance and a further red shifting with a simultaneous weakening (decreasing amplitude) of the red shifted outer Al shell resonance. Eventually as the core grows further and the dielectric layer becomes yet thinner the red shifted outer Al resonance goes further into the infrared while its amplitude approaches zero. In the limit of zero dielectric layer thickness only an undisturbed deep uv core resonance remains. Thus a conductive core, not unlike a dielectric core, can also push the shell resonance toward the red. Qualitatively similar results are expected from particles where the Al is substituted by Ag, Mg or other metallic substances with a Froehlich resonance.

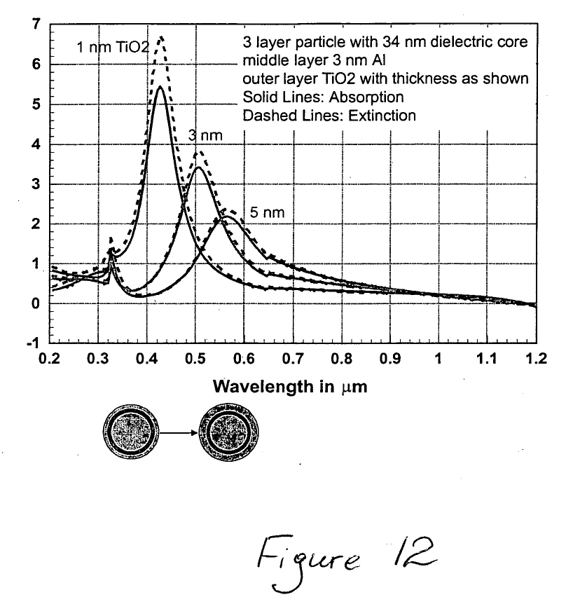

In FIG. 12 two techniques are shown that can be applied simultaneously to achieve large red shifts of the free electron Plasmon resonance. As shown above, the shift is the larger the thinner the conductor is. A high dielectric constant coating can also produce a red shift. Both techniques can be applied simultaneously, as shown in FIG. 12. Their effects are additive. In this way one can achieve large shifts.

A yet more elaborate particle having a core and three layers. A particle has been analyzed having a dielectric core diameter of x nm, where x can be anywhere from 0 to 20 nm. The first Ag conductor layer extends from x to 20 nm diameter. The second dielectric layer extends from 20 nm to 20+x nm. The final Ag layer extends from 20+x to 40 nm. Now both the resonances of the two Ag layers change in position considerably as x is allowed to increase. Separate tuning of the two absorption peaks is accomplishes by varying the thickness of the two dielectric layers independently. Obviously different free electron conductors can be substituted for each of the two conducting layers. All other type of permutations of materials can be used where at least one of the layers or core is a free electron conductor.

One skilled in the art will understand that, in general, colorant particles of the present invention can be manufactured in any of the following embodiments.

In one embodiment, particles of the present invention can have a core that includes a first dielectric material, the first shell includes a conducting material, and the second shell includes a second dielectric material.

In another embodiment, particles of the present invention can have the core that includes a first conducting material, the first shell includes a dielectric material, and the second shell includes a second conducting material.

In another embodiment, particles of the present invention can have the core that includes a dielectric material, the first shell includes a first conducting material and the second shell includes a second conducting material.

In another embodiment, particles of the present invention can have the core that includes a first conducting material, the first shell includes a second conducting material and the second shell includes a dielectric material.

In another embodiment, particles of the present invention can have the core that includes a first conducting material, the first shell includes a first dielectric material, and the second shell includes a second dielectric material.

In another embodiment, particles of the present invention can have the core that includes a first dielectric material, the first shell includes a second dielectric material, and the second shell includes a conducting material.

In another embodiment, particles of the present invention can have the core that includes a first conducting material, the first shell includes a second conducting material and the second shell includes a third conducting material.

In another embodiment, particles of the present invention can have the core that includes a first dielectric material, the first shell includes a second dielectric material and the second shell includes a third dielectric material.

Particle Size

To actually determine optimal particle sizes it is best to plot transmission, absorption and extinction. It is true that the absorption cross-section decreases for small particles. However, there are many more particles present per unit weight than big particles. Analysis of the absorption coefficient of a suspension of TiN particles with a given total mass per unit volume of suspension as a function of particle size and wavelength shows that up to a maximum radius of about 0.025 micrometer the magnitude of absorption does not depend on particle radius. This means that the relative absorption cross-section varies proportional to the radius r of the particle for radii smaller than about 0.25 micrometer. Thus the total absorption cross-section is proportional to the physical cross-section πr² multiplied with the relative cross-section, which is proportional to r. In other words the total absorption cross-section of a small particle varies as r³, just as the volume of the particle. Thus if we disperse small particles their absorption depends on the total mass of all the particles per unit volume of dispersion and not on their size, provided the size is not above a certain limit (here about 0.025 micrometer or 25 nm radius).

It is useful to realize that the effective “optical size” can be vastly larger than the physical size of the particle, thus resulting in proportionally enormous savings of colorant weight to achieve economic savings yielding great economic benefits.

Applications

The present invention can be used in a wide range of applications that include UV blockers, color filters, ink, paints, lotions, gels, films, and solid materials.

It should be noted that resonant nature of the radiation absorption by the particles of the present invention results in (a) absorption cross-section greater than unity and (b) narrow-band frequency response. These properties result in an “optical size” of a particle being greater than its physical size, which allows reducing the loading factor of the colorant sometimes by a factor of 100X per unit area or more. Small size, in turn, helps to reduce undesirable radiation scattering. Low loading factor has an effect on the economy of use. Narrow-band frequency response allows for superior quality filters and selective blockers. The pigments based on the particles of the present invention do not suffer from UV-induced degradation, are light-fast, non-toxic, resistant to chemicals, stable at high temperature, and are non-carcinogenic.

The particles of the present invention can be used to block a broad spectrum of radiation: from ultraviolet (UV) band, defined herein as the radiation with the wavelengths between 200 nm and 400 nm, to the visible band (VIS), defined herein as the radiation with the wavelengths between about 400 nm and about 700 nm. As a non-limiting example, particles of the present invention can be dispersed in an otherwise clear carrier such as glass, polyethylene or polypropylene. The resulting radiation-absorbing material will absorb UV radiation while retaining good transparency in the visible region. A container manufactured from such radiation-absorbing material may be used, for example, for storage of UV-sensitive materials, compounds or food products.

Cores and shells comprising metals can be used to produce particles absorbing in UV band.

Particles with strong, wavelength-specific absorption properties make excellent pigments for use in ink and paint composition. Color is created when a white light passes through or is reflected from a material that selectively absorbs a narrow band of frequencies. Thus cores and shells comprising free electron conductors, such as TiN, HfN, and ZrN, as well as other metals and high-refracting index dielectric materials can be used to produce particles absorbing in the visible range and which, therefore, become useful as pigments.

Suitable carriers for the particles of the present invention include polyethylene, polypropylene, polymethylmethacrylate, polystyrene, polyesthers and copolymers thereof. A film or a gel, comprising ink or paints described above, are contemplated by the present invention.

The particles of the present invention can be further embedded in beads in order to ensure a minimal distance between the particles. Preferably, beads are embedded individually in transparent spherical plastic or glass beads. Beads, containing individual particles can then be dispersed in a suitable carrier material.

The particles of the present invention can also be used as highly effective color filters. Conventional filters often suffer from “soft shoulder” spectral absorption, whereby a rather significant proportion of unwanted frequency bands is absorbed along with the desirable band. The particles of the present invention, by virtue of the resonant absorption, provide a superior mechanism for achieving selective absorption. The color filters can be manufactured by dispersing the particles of the present invention in a suitable carrier, such as glass or plastic, or by coating a desired material with film, comprising the particles of the present invention.

Combining particles of different types within the same carrier material is also contemplated by the instant invention.

Particles of the present invention can be used as signal-producing entities used in biomedical applications such as cytostaining, immunodetection, and competitive binding assays. As a non-limiting example, a particle can be covalently attached to an antibody. Such composition can be used to contact a sample of tissue and illuminated by white light. The visual signal, generated by the particle's absorption of a predetermined frequency band, can be detected by standard techniques known in the art, such as microscopy. One skilled in the art will recognize that entities other than antibodies can be covalently attached to a particle of the present invention. Peptides, nucleic acids, saccharides, lipids, and small molecules are contemplated to be attachable to the particles of the present invention.

Methods of Manufacture

Although particles suitable for use in the applications described above can be produced through any number of commercial processes, we have devised a preferred manufacturing method for vapor-phase generation. This method is described in U.S. Pat. No. 5,879,518 and U.S. Patent App Pub. US 2004/0147362. Both these references are incorporated herein by reference in their entirety.

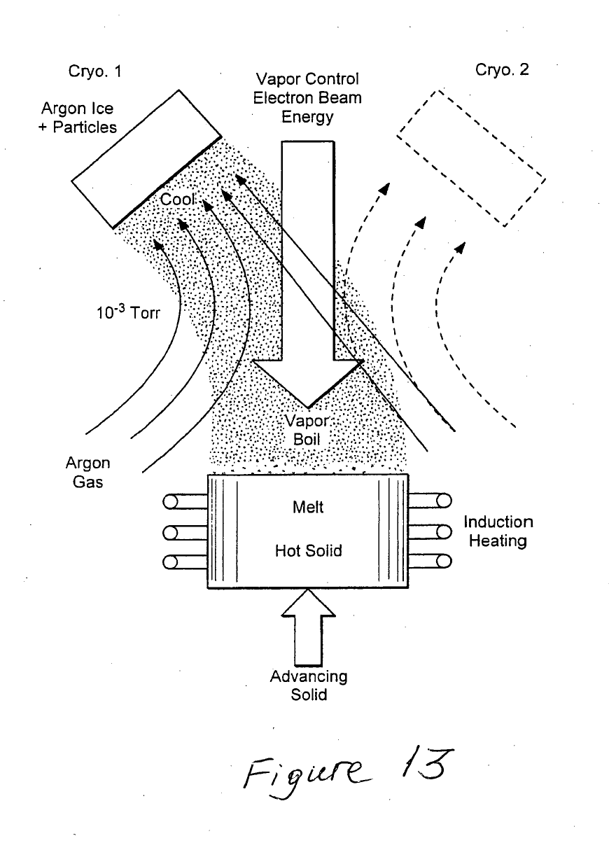

This method, schematically illustrated in FIG. 13, uses a vacuum chamber in which materials used to manufacture cores are vaporized as spheres and encapsulated before being frozen cryogenically into a block of ice, where they are collected later. The control means for arriving at monodispersed (uniformly sized) particles of precise stoichiometry and exact encapsulation thickness relate to laminar flow rates, temperatures, gas velocities, pressures, expansion rates from the source, and percent composition of gas mixtures.

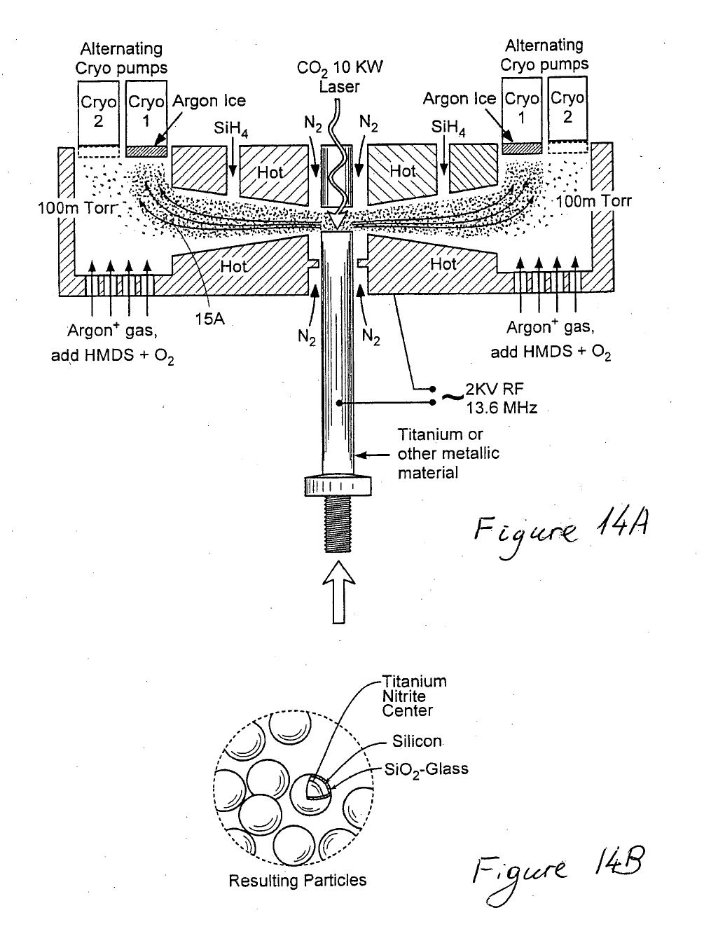

Referring to FIGS. 14A and 14B, in a preferred embodiment, a supply of titanium may be used, as an example. Titanium or other metallic material is evaporated at its face by incident CO₂ laser beam or other wavelength laser to produce metal vapor droplets. The formation of these droplets can be aided, for narrower size control, by establishing an acoustic surface wave across the molten surface to facilitate the release of the vapor droplets by supplying amplitudinal, incremental mechanical peak energy.

The supply rod is steadily advanced forward as its surface layer is used up to produce vapor droplets. The latter are swept away by the incoming nitrogen gas (N₂) that, at the central evaporation region, becomes ionized into “N” via a radio frequency (RF) field (about 2 kV at about 13.6 MHz). The species of atomic nitrogen “N⁺” react with the metal vapor droplets and change them into TiN or other metal nitrides such as ZrN or HfN, depending on the material of the supply rod.

Due to vacuum differential pressure and simultaneous radial gas flow in the conically shaped circular aperture, the particles travel, with minimum collisions, into an argon upstream to reach several strategically placed alternating cryogenic pumps which “freeze out” and solidify the gases to form blocks of ice in which the particles are embedded.

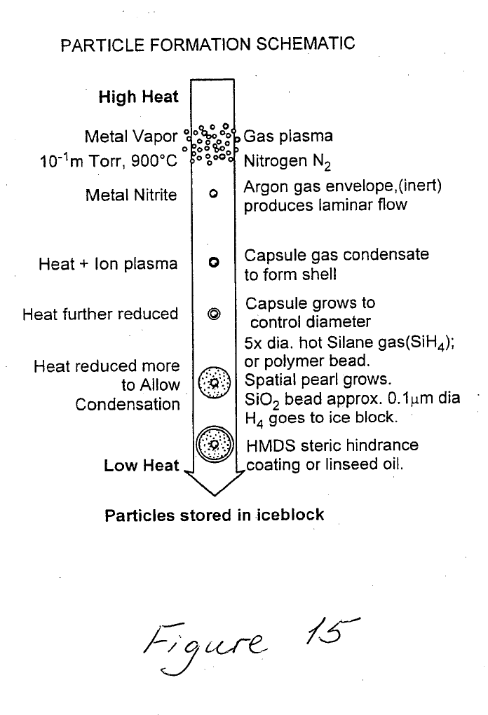

The steps of particle formation are shown in FIG. 15. Here we begin with metal vapor plus atomic nitrogen gas to form metal nitrides. By imparting onto the particles a temporary electric charge, we can keep them apart, and thus prevent collisions, while beginning to grow a thin shell around the nitride core. As non-limiting examples, silicon or TiO₂ can be used, wherein the thickness of the shell is controlled by the rate of supply of silane gas (SiH4) or a mixture of TiCl₄ and oxygen, respectively.

In a subsequent passage zone, silane gas or a TiCl₄/O₂ mixture are condensed on a still hot nanoparticle to form a SiO₂ or TiO₂ spherical enclosure around each individual particle.

If required, a steric hindrance layer of a surfactant, such as, for example, hexamethyl disiloxane (HMDS), can be deposited on the beads to keep the particles evenly dispersed throughout a carrier of choice, such as, for example, oil or polymers. Other surfactants can be used in water suspension.

With this manufacturing method, a variety of encapsulated nanoparticles can be produced in large quantities, generating in one single process step the desired resonant-absorption particles and assure their collectability and their uniform size.

While this invention has been particularly shown and described with references to preferred embodiments thereof, it will be understood by those skilled in the art that various changes in form and details may be made therein without departing from the scope of the invention encompassed by the appended claims.

What is claimed is:

1. An electromagnetic radiation-absorbing particle, comprising:
(a) a core;
(b) a first shell encapsulating the core; and
(c) at least one additional shell encapsulating the first shell,
wherein the first shell has the refractive index different from the refractive index of the core and the refractive index of the at least one additional shell.

2. The particle of claim 1, comprising:
a core;
a first shell; and
a second shell,
wherein the core, the first shell and the second shell each independently include a dielectric material or a conducting material.

3. The particle of claim 2, wherein the core includes a first dielectric material, the first shell includes a conducting material, and the second shell includes a second dielectric material.

4. The particle of claim 2, wherein the core includes a first conducting material, the first shell includes a dielectric material, and the second shell includes a second conducting material.

5. The particle of claim 2 wherein the core includes a dielectric material, the first shell includes a first conducting material and the second shell includes a second conducting material.

6. The particle of claim 2 wherein the core includes a first conducting material, the first shell includes a second conducting material and the second shell includes a dielectric material.

7. The particle of claim 2 wherein the core includes a first conducting material, the first shell includes a first dielectric material, and the second shell includes a second dielectric material.

8. The particle of claim 2, wherein the core includes a first dielectric material, the first shell includes a second dielectric material, and the second shell includes a conducting material.

9. The particle of claim 2, wherein the core includes a first conducting material, the first shell includes a second conducting material and the second shell includes a third conducting material.

10. The particle of claim 2, wherein the core includes a first dielectric material, the first shell includes a second dielectric material and the second shell includes a third dielectric material.

11. The particle of claim 2, wherein said particle exhibits an absorption cross-section greater than 1 in a predetermined spectral band.

12. The particle of claim 2 wherein the particle has a diameter from about 0.1 nm to about 300 nm.

13. The particle of claim 2, wherein the dielectric material is selected from the group consisting of Si, SiO₂, ZrO₂ and TiO₂ and Al₂O₃.

14. The particle of claim 2, wherein the conducting material is selected from the group consisting of Au₁, Ag, Al, Mg, Cu, Ni, Cr, TiN, ZrN, and HfN.
